(19) United States
(12) Patent Application Publication
(10) Pub. No.: US 2008/0077262 A1
(43) Pub. Date: Mar. 27, 2008

(54) Distortion free stitching of digital media files

(75) Inventor: Stephen A. Davis, Los Gatos, CA (US)

Correspondence Address: TECHNOLOGY & INNOVATION LAW GROUP, PC, ATTN: 101, 19200 STEVENS CREEK BLVD., SUITE 240, CUPERTINO, CA, 95014, US

(73) Assignee: APPLE COMPUTER, INC, CUPERTINO, CA (US)

(21) Appl. No.: 11/518,034

(22) Filed: Sep. 8, 2006

(51) Int. Cl. G06F 17/00

(52) U.S. Cl. 700/94

(57) ABSTRACT

Distortion free stitching of two temporally adjacent digital media files of any format or origin is described. Two digital media files are selected and placed temporally adjacent to each other. A determination is then made of the direction of each of the waveforms and an associated delta value between a last audio sample of a first to be played media file and a first audio sample of a next to be played media file. A stitching operation is performed, or not, based upon the respective directions of the waveforms and the associated delta value.

### BACKGROUND OF THE INVENTION

1. Field of the Invention

This invention relates generally to digital media files. More specifically, the invention describes a distortion free stitching of two temporally adjacent digital media files that have been butt spliced. Such files include, but are not limited to, digital audio files.

2. Description of Related Art

Recent developments in consumer electronics have included the introduction of multimedia asset player devices (such as the iPOD™ player manufactured by Apple Computer Inc. of Cupertino, Calif.) capable so storing a large number of digital data files such as audio or video files. In some cases, in order to store an ever larger number of data files, various data compression techniques have been used to reduce the size of the stored digital data files. These compression techniques fall into one of two categories, lossless compression (ALAC, etc) that is a class of data compression algorithms that allow the exact original data to be reconstructed from the compressed data. In contrast, lossy data compression (AAC, MP3) is a class of data compression algorithms that do not allow the exact original data to be reconstructed from the compressed data. It should be noted that due to the inherent nature of the lossy encoding process, discontinuities in the original waveform are introduced at both the beginning and ending of the compressed data file.

With the availability of such a large number of multimedia files (audio files for example) it has become very popular to create custom “albums” by placing selected digital audio files in a pre-selected order and performing what is referred to as a butt splice. A butt splice is the abrupt connection of one audio file to another audio file so that they become one continuous audio file (along the lines of concept albums such as “Dark Side of the Moon”), which can then, for example, be burned onto a playable storage medium such as a CD or played back directly from a media player. It would therefore be advantageous to be able to perform a butt splice on any two audio files regardless of their respective formats or origins.

Unfortunately, however, there are a number of scenarios where a butt splice of two files will in all likelihood result in an audible distortion (such as a click or a pop) due to a discontinuity at the transition point. One such scenario is when two audio files (referred to as a Track A and a Track B) are not from the same album and have nothing to do with each other. Most of the time, the streams will both end and start with zero, however, if Track A is part of an album with seamless track transitions, then it will not end at zero and there will be a discontinuity when it is paired with any track which is not its normal partner. Alternately, Track A could end at zero and Track B could start at a non-zero (or vice versa) value also resulting in a discontinuity and yet another scenario is one in which both tracks have non-zero transitions.

This problem extends to those scenarios where compressed audio files that have been processed by a lossy compression algorithm are butt spliced. Since files compressed using a lossy compression algorithm have non-audio samples at the beginning of the data file and at the ending of the data file, butt splicing these files (without properly trimming the non-audio samples near the transition point) will in all likelihood result in an audible distortion at the transition point. Even in those cases where the two files to be butt spliced were encoded using lossless compression and in their original form “meshed” properly, an audible distortion may become evident if one or both of the two tracks have undergone some form of sound effects processing (i.e., EQ, Sound Enhancer, etc.). For example, if a Track A is encoded with WAV and a Track B with AIFF and if sound effects processing has been turned on (i.e., EQ, Sound Enhancer, etc.) then even though the two tracks have been losslessly encoded, the two tracks will not in all likelihood match up at the transition point resulting in an audible distortion such as a click or pop.

What is required is distortion free butt splicing of any two digital media files regardless of format or origin.

### SUMMARY OF THE INVENTION

The invention described herein pertains to distortion free stitching of two temporally adjacent digitally encoded multimedia files. In a described embodiment, a method of distortion free stitching of two temporally adjacent digital media files together is described. The method includes the following operations: determining a direction of the track A waveform and the track B waveform; determining a delta value between a last audio sample of the track A waveform and a first audio sample of the track B waveform; and stitching the track A waveform and the track B waveform together based upon the directions of the tracks A and B and the associated delta value.

In another embodiment, computer program product executable by a processor for distortion free stitching of two temporally adjacent digital media files together is described. The computer program product includes computer code for computer code for determining a direction of the track A waveform and the track B waveform; computer code for determining a delta value between a last audio sample of the track A waveform and a first audio sample of the track B waveform; computer code for stitching the track A waveform and the track B waveform together based upon the directions of the tracks A and B and the associated delta value; and computer readable medium for storing the computer code.

In yet another embodiment, an apparatus arranged to perform a distortion free stitching operation of two multimedia files together. The apparatus includes a memory unit for arranged to store data that includes a plurality of digital multimedia files; and a processor coupled to the memory unit arranged to, determine a direction of the track A waveform and the track B waveform; determine a delta value between a last audio sample of the track A waveform and a first audio sample of the track B waveform; and stitch the track A waveform and the track B waveform together based upon the directions of the tracks A and B and the associated delta value.

### BRIEF DESCRIPTION OF THE DRAWINGS

The invention will be better understood by reference to the following description taken in conjunction with the accompanying drawings.

FIG. 1 shows a flowchart detailing a process for distortion free stitching of two temporally adjacent digital media files in accordance with an embodiment of the invention.

FIG. 2 show representative waveforms and their respective directions in accordance with an embodiment of the invention.

FIGS. 3A-3B shows a representative linear extrapolation type stitching operation in accordance with an embodiment of the invention.

### DETAILED DESCRIPTION OF SELECTED EMBODIMENTS

Reference will now be made in detail to a preferred embodiment of the invention. An example of the preferred embodiment is illustrated in the accompanying drawings. While the invention will be described in conjunction with a preferred embodiment, it will be understood that it is not intended to limit the invention to one preferred embodiment. To the contrary, it is intended to cover alternatives, modifications, and equivalents as may be included within the spirit and scope of the invention as defined by the appended claims.

With the rapid advancement in the ability to store data, multimedia asset players can accommodate hundreds or even thousands of digital media files, such as audio files, providing a user the ability to create customized albums. With the availability of such a large number of multimedia files it has become very popular to create custom “albums” by placing selected digital audio files in a pre-selected order and performing what is referred to as a butt splice. A butt splice is the abrupt connection of one audio file to another audio file so that they become one continuous audio file (along the lines of concept albums such as “Dark Side of the Moon”), which can then, for example, be burned onto a playable storage medium such as a CD. Unfortunately, however, there are a number of scenarios where a butt splice of two files will in all likelihood result in an audible distortion (such as a click or a pop) due to a discontinuity at the transition point. Such discontinuities can have many sources, including butt splicing lossy compressed media files (such as MP3 files) having a number of non-audio files at the beginning and ending of the file, or butt splicing audio files from different origins that do not sonically match at the transition point, etc. Therefore, the invention provides for distortion free stitching of digital files of any format or origin.

In one embodiment, first (track A) and second (track B) digital audio tracks are retrieved and placed in a play order {A:B} by which it is meant that the last audio content of the track A will be expressed immediately followed in time by the first audio samples of the track B without any noticeable pause. As part of the inventive process, the direction of the track A and the track B is determined in a transition zone based upon a last audio sample of the track A and the first audio sample of the track B. The transition zone typically ranges from about 10 msec prior to the end of track A to about 10 ms from the beginning of track B. Once the directions of the tracks have been determined in the transition zone, a determination of a difference value (referred to as a delta (δ)) is made between the last audio sample of the track A and the first audio sample of the track B.

In the described embodiment, the delta (δ) is based upon a fractional change (where fractional change=absolute value((B−A)/A) where B is value of the first sample of track B and A is value of the last sample of track A) between the respective values of the track A last audio sample and the track B first audio sample. However, in certain cases such as when the direction of either of the tracks is flat (i.e., neither upward nor downward going), or either the last audio sample of the track A or the first audio sample of the track B has a zero value, the fractional approach would render a meaningless result. In these situations, the invention provides for determining an absolute value difference of the first and last respective audio samples. In any case, the invention provides for stitching the track A and the track B, or not, based upon a pre-determined relationship between the directions of track A and track B and the associated delta value. For example, if the direction of the track A and the direction of the track B are substantially the same and the associated delta value is approximately zero, then no stitching is performed. However, if the directions do not match (i.e., one is upward going and the other is downward going, or vice versa), and the associated delta value is greater than or equal to a first pre-determined value, then a stitching operation is performed. In a particularly useful embodiment, the stitching operation is a linear cross fade operation well known to those skilled in the art. In this way, the tracks A and B are stitched together resulting in an audibly smooth transition between the two tracks (i.e., without a noticeable audio distortion at the junction of the two tracks).

More specifically, if the directions of Track A and Track B are the same and (δ) is less than 0.5 then no stitching operation is performed. However, if the directions of Track A and Track B are different and if there and the endpoints are not zero and (δ) is less than 0.3 then there is also no stitching. However if there are zeros, and the absolute difference of (B−A) is less than or equal to 0.25 then no stitching is performed, otherwise stitching is performed. It should be noted that there is a special check for a “zeros” case where, if the direction of both Track A and Track B are flat and the values are approximately zero, no stitching is performed (it should be noted that “approximately zero” is defined as the absolute amplitude of the sample value<=2/32768. Since 16-bit audio has 65536 steps of precision this allows values within +/−2 steps to be treated as “0”).

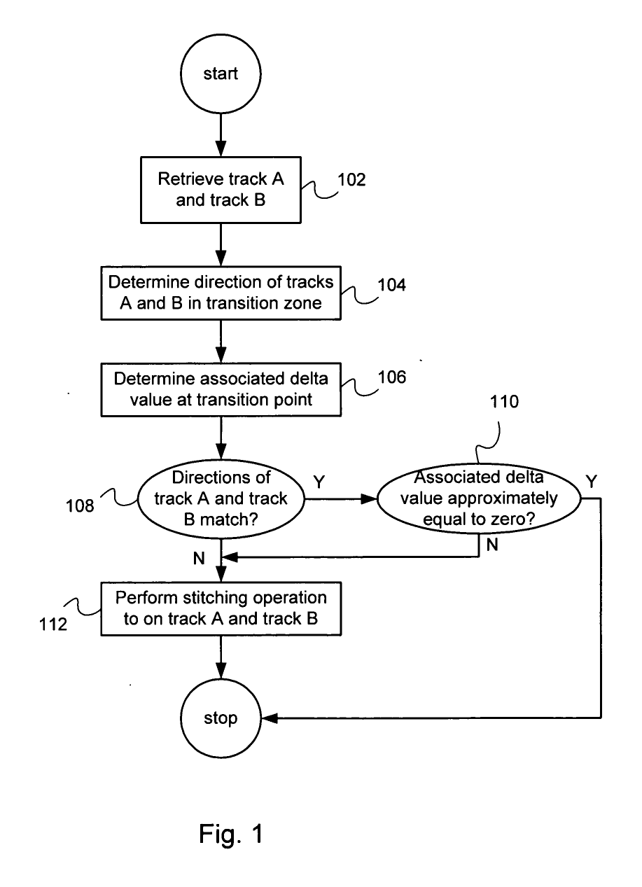

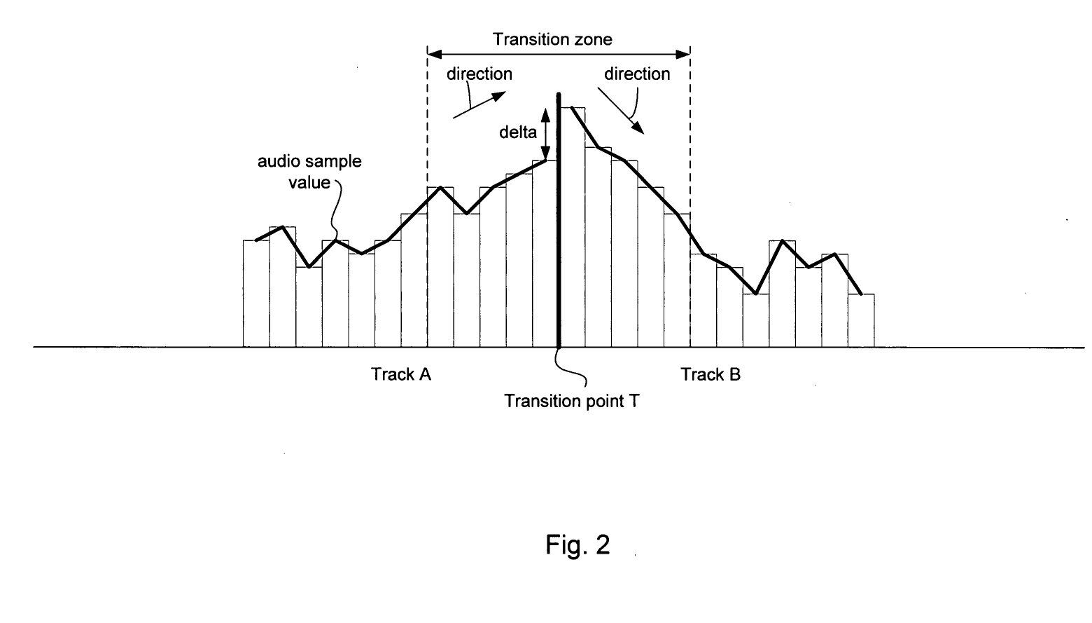

FIG. 1 shows a flowchart detailing a process 100 for distortion free stitching of two temporally adjacent digital media files in accordance with an embodiment of the invention. The process 100 begins at 102 by retrieving a first track A and a first track B which are to be stitched together such that there is no audible gap output when the tracks are placed temporally adjacent to each other and decoded by an appropriate decoder regardless of the MP3 encoder used to create the tracks A and B originally. At 102, the direction of the track A and the track B are determined. In the described embodiment, the direction of the track A and the track B is determined based upon calculating and comparing values for each of a number of audio samples for each track that lie within or near a transition zone between the two tracks. (It should be noted that typically the transition zone is about 10 ms wide which would be 441 samples at a 44.1 kHz sample rate). For example, FIG. 2 shows a case whereby a track A 200 is determined to have an upward going waveform in a transition zone 202 whereas a track B 204 is determined to have a downward going waveform in the transition zone 202.

Returning to FIG. 1, at 104, a delta value at a transition point between the two tracks is determined. In the described embodiment, the delta value is based upon a fractional change between the last audio sample value of the track A and the first audio sample value of the track B. At 106, if the directions of the tracks match (this includes the case whereby the directions of each of the tracks match and are considered to be flat), and the associated delta is approximately zero, then there is no stitching required and the process 100 ends. If, however, at 108, if the directions do not match (i.e., one direction is upward going and the other is downward going, or one or the other is flat whereas the other is not), then a stitching operation is carried out. In the described embodiment, the stitching operation is a linear cross fade operation whereby a track A is ramped down (multiplied by an appropriate downward going ramp function) and a track B is ramped up (multiplied by an appropriate upward going ramp function) the results of which are overlapped and added over the transition zone.

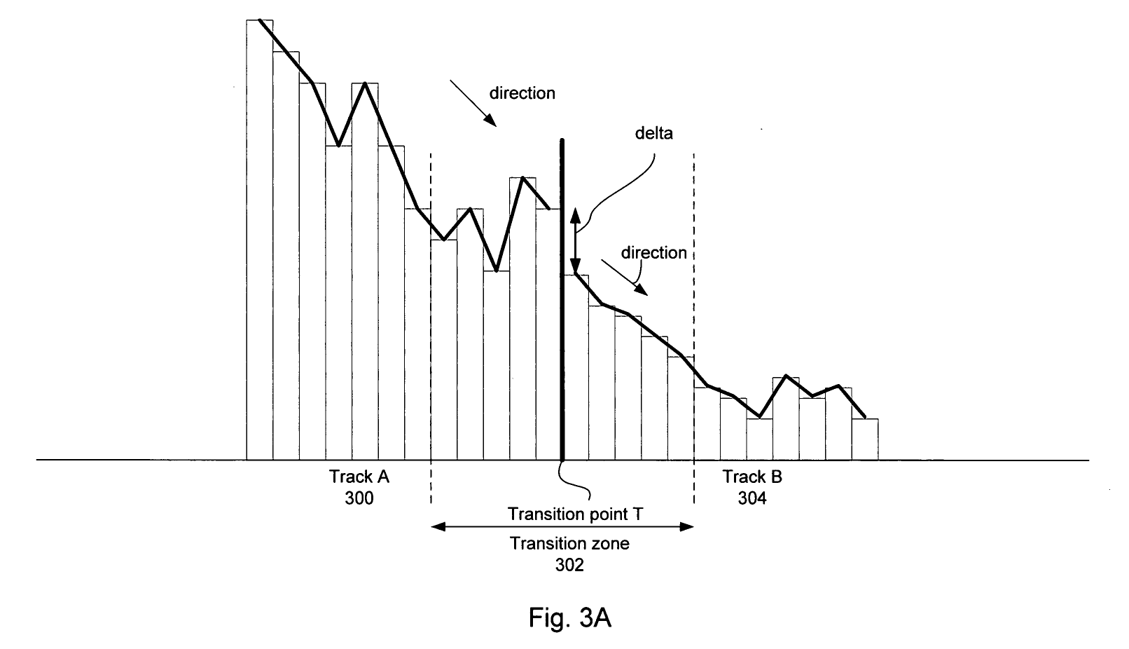

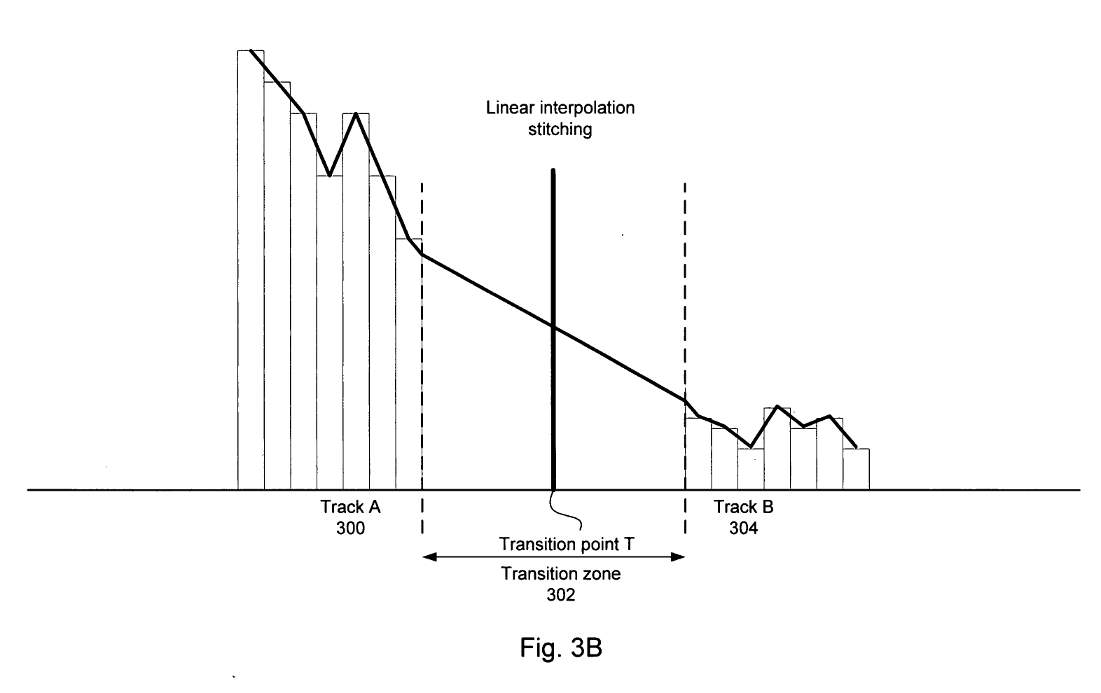

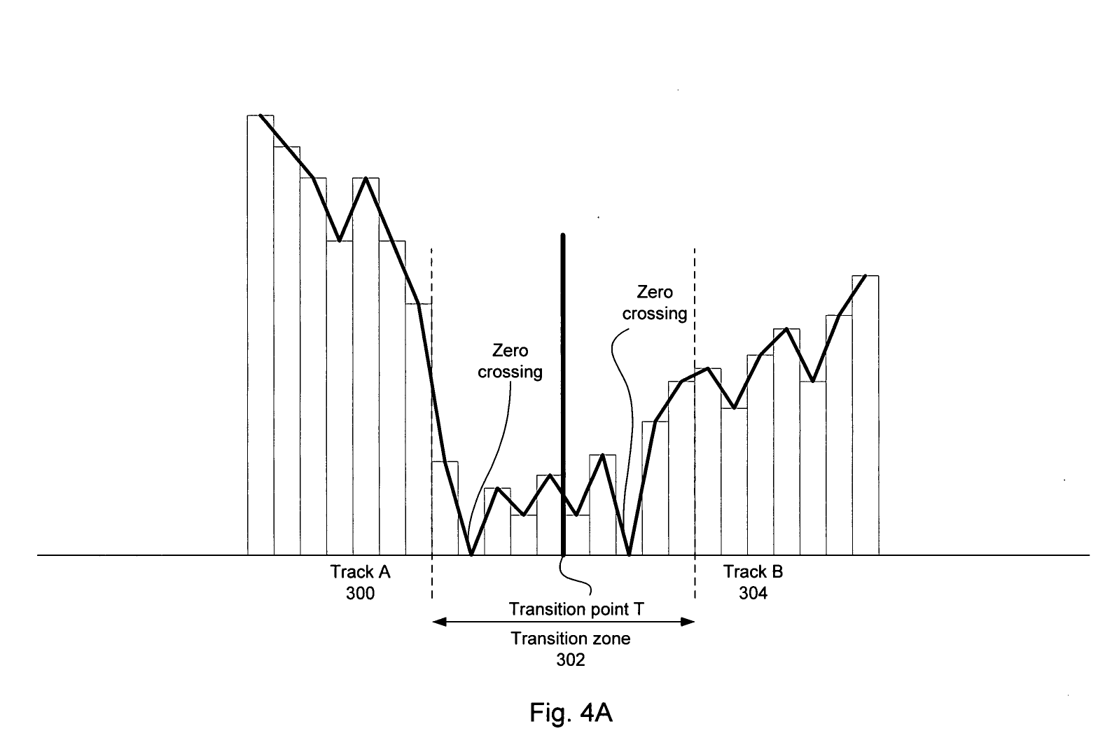

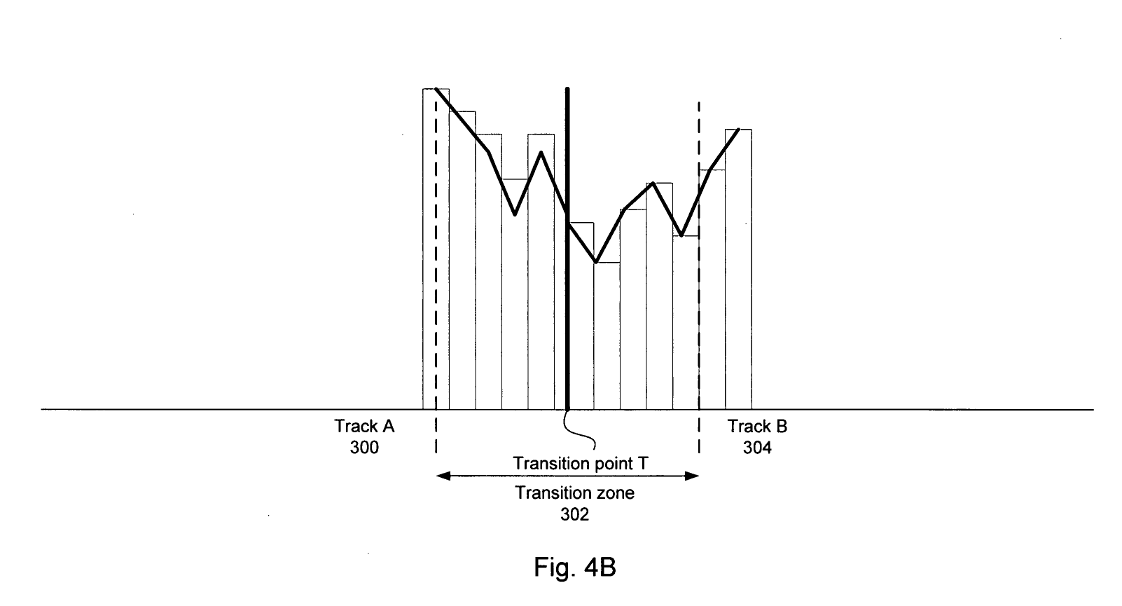

In some situations, other stitching operations can be performed in addition to the linear cross fade. For example, if the directions match and the associated delta value is greater than a pre-determined threshold value (see FIG. 3A), then a linear interpolation type stitching operation can be performed as illustrated in FIG. 3B. In other situations (such as in the case where processing resources are at a premium and more processor intensive operations such as the linear cross fade could not economically be implemented), a zero crossing type stitching operation can be performed. In this case, the region between the zero crossing points is eliminated and the two waveforms are then stitched by moving the zero crossing points of the track A waveform and the track B waveform together at the transition point T.

While this invention has been described in terms of a preferred embodiment, there are alterations, permutations, and equivalents that fall within the scope of this invention. It should also be noted that there are many alternative ways of implementing both the process and apparatus of the present invention. It is therefore intended that the invention be interpreted as including all such alterations, permutations, and equivalents as fall within the true spirit and scope of the present invention.

What is claimed is:

1. A method of distortion free stitching a digitally encoded track A waveform and a digitally encoded track B waveform at a transition point T, comprising;
determining a direction of the track A waveform and the track B waveform;
determining a delta value between a last audio sample of the track A waveform and a first audio sample of the track B waveform; and
stitching the track A waveform and the track B waveform together based upon the directions of the tracks A and B and the associated delta value.

2. A method as recited in claim 1, wherein when the directions of the track A waveform and the track B waveform substantially match and the associated delta value is substantially zero, then there is no stitching performed on the two tracks.

3. A method as recited in claim 1, wherein when the direction of the track A waveform and the track B waveform do not match and the associated delta value is greater than a first predetermined threshold value, then the stitching operation is a linear cross fade operation

4. A method as recited in claim 1, further comprising:
juxtaposing the track A waveform prior to the track B waveform such all of the audio samples of the track A waveform are expressed prior to any of audio samples of the track B waveform.

5. A method as recited in claim 1, wherein the transition zone is approximately 10 ms wide.

6. A method as recited in claim 4 wherein determining the direction of the track A waveform comprises;
determining a last track A audio sample value;
determining a previous to last track A audio sample;
comparing the last track A audio sample value to the previous to last track audio sample.

7. A method as recited in claim 4 wherein determining the direction of the track B waveform comprises;
determining a first track B audio sample value;
determining a subsequent to first track B audio sample;
comparing the first track B audio sample value to the subsequent to first audio sample.

8. A method as recited in claim 7, wherein determining the delta value comprises:
determining a fractional change between the last track A audio sample value and the first track B audio sample value.

9. A method as recited in claim 8, wherein the fractional change is the absolute value ((B−A)/A), wherein B is the first track B audio sample value and wherein A is the last track A audio sample value.

10. A method as recited in claim 1, wherein the track A and the track B are stitched in real time during playback from a media player.

11. A method as recited in claim 1, wherein after the track A and the track B are stitched, the stitched tracks are stored in a storage medium.

12. A method as recited in claim 1, wherein the Track A and Track B are compressed media files that include MP3 files that are stored in a portable MP3 player.

13. Computer program product executable by a processor for distortion free stitching a digitally encoded track A waveform and a digitally encoded track B waveform at a transition point T, comprising;
computer code for determining a direction of the track A waveform and the track B waveform;
computer code for determining a delta value between a last audio sample of the track A waveform and a first audio sample of the track B waveform;
computer code for stitching the track A waveform and the track B waveform together based upon the directions of the tracks A and B and the associated delta value; and
computer readable medium for storing the computer code.

14. Computer program product as recited in claim 13, wherein when the directions of the track A and the track B substantially match and the associated delta value is substantially zero, then there is no stitching performed on the two tracks.

15. Computer program product as recited in claim 13, wherein when the direction of the track A and the track B do not match and the associated delta value is greater than a predetermined threshold value, then the stitching operation is a linear cross fade operation

16. Computer program product as recited in claim 13 further comprising:
computer code for juxtaposing the track A waveform prior to the track B waveform such all of the audio samples of the track A waveform are expressed prior to any of audio samples of the track B waveform.

17. Computer program product as recited in claim 13, wherein the transition zone is approximately 10 ms wide.

18. Computer program product as recited in claim 13 wherein computer code for determining the direction of the track A waveform comprises;
computer code for determining a last track A audio sample value;
computer code for determining a previous to last track A audio sample;
computer code for comparing the last track A audio sample value to the previous to last track audio sample.

19. Computer program product as recited in claim 18 wherein determining the direction of the track B waveform comprises;
computer code for determining a first track B audio sample value;
computer code for determining a subsequent to first track B audio sample;
computer code for comparing the first track B audio sample value to the subsequent to first audio sample.

20. Computer program product as recited in claim 19, wherein the computer code for determining the delta value comprises:
computer code for determining a fractional change between the last track A audio sample value and the first track B audio sample value.

21. Computer program product as recited in claim 10, wherein the fractional change is the absolute value ((B−A)/A), wherein B is the first track B audio sample value and wherein A is the last track A audio sample value.

22. An apparatus arranged to perform a distortion free stitching operation of two multimedia files together, comprising:
a memory unit for arranged to store data that includes a plurality of digital multimedia files; and
a processor coupled to the memory unit arranged to,
determine a direction of the track A waveform and the track B waveform;
determine a delta value between a last audio sample of the track A waveform and a first audio sample of the track B waveform; and
stitch the track A waveform and the track B waveform together based upon the directions of the tracks A and B and the associated delta value.

23. An apparatus as recited in claim 22, wherein when the directions of the track A waveform and the track B waveform substantially match and the associated delta value is substantially zero, then there is no stitching performed on the two tracks.

24. An apparatus as recited in claim 22, wherein when the direction of the track A waveform and the track B waveform do not match and the associated delta value is greater than a first predetermined threshold value, then the stitching operation is a linear cross fade operation

25. An apparatus as recited in claim 22, further comprising:
wherein the processor further juxtaposes the track A waveform prior to the track B waveform such all of the audio samples of the track A waveform are expressed prior to any of audio samples of the track B waveform.

26. An apparatus as recited in claim 22, wherein the transition zone is approximately 10 ms wide.

27. An apparatus as recited in claim 26 wherein the determining the direction of the track A waveform comprises;
determining a last track A audio sample value;
determining a previous to last track A audio sample;
comparing the last track A audio sample value to the previous to last track audio sample.

28. An apparatus as recited in claim 27 wherein determining the direction of the track B waveform comprises;
determining a first track B audio sample value;
determining a subsequent to first track B audio sample;
comparing the first track B audio sample value to the subsequent to first audio sample.

29. An apparatus as recited in claim 28, wherein determining the delta value comprises:
determining a fractional change between the last track A audio sample value and the first track B audio sample value.

30. An apparatus as recited in claim 29, wherein the fractional change is the absolute value ((B−A)/A), wherein B is the first track B audio sample value and wherein A is the last track A audio sample value.
